(19) United States
(12) Patent Application Publication
(10) Pub. No.: US 2018/0082265 A1
(43) Pub. Date: Mar. 22, 2018

(54) GENERATING ACTIVITY SUGGESTIONS TO ASSIST USER IN MAINTAINING WORK-LIFE BALANCE

(71) Applicant: International Business Machines Corporation, Armonk, NY (US)

(72) Inventors: Ka Lai Chan, Hong Kong (HK); Wai Ho Chan, Hong Kong (HK); Pei Man Josephine Ann Liu, Hong Kong (HK); Chiu Hang Tsang, Hong Kong (HK)

(21) Appl. No.: 15/270,961

(22) Filed: Sep. 20, 2016

(51) Int. Cl. G06Q 10/10

(52) U.S. Cl. CPC G06Q 10/1095; G06Q 50/01

(57) ABSTRACT

A method, system and computer program product for assisting users to maintain a desired work-life balance. A desired work-life balance ratio (ratio of time spent between two or more categories (e.g., work, leisure, family) among work and lifestyle) is provided by the user. One or more calendar systems are analyzed to determine the current work-life balance ratio over a duration of time. An activity pool containing a list of activities is analyzed to identify activities to suggest to the user to enable the current work-life balance ratio to match the desired work-life balance ratio in response to the current work-life balance ratio not matching the desired work-life balance ratio. A list of the activities identified is then provided to the user to enable the current work-life balance ratio to match the desired work-life balance ratio. In this manner, the user is better able to achieve the user's desired work-life balance.

### TECHNICAL FIELD

The present invention relates generally to calendar systems, and more particularly to generating activity suggestions (e.g., play badminton with friend John Doe) to assist the user in maintaining a work-life balance.

### BACKGROUND

Calendar systems (e.g., Google® calendar) utilize software that minimally provides users with an electronic version of a calendar. Additionally, the calendar systems may provide an appointment book, address book, and/or contact list.

Currently, people have become more concerned about maintaining a “work-life balance” where they attempt to establish a balance between work (e.g., career and ambition) and lifestyle (e.g., health, pleasure, leisure, family and spiritual development/meditation). In connection with maintaining such a work-life balance, people may manually enter activities (e.g., work, leisure and family activities) into a calendar system so as to track their schedule to determine if they are maintaining their desired work-life balance.

However, determining one's current work-life balance in such a manner may be difficult, such as in the scenario where the user has an excessive number of activities scheduled in the user's calendar. Even if a person is able to determine their work-life balance from their calendar, the person may be unsure how to incorporate more activities, such as lifestyle activities, to achieve their desired work-life balance if the person's current work-life balance is not acceptable to them.

Hence, there is not currently a means for assisting users to determine their current work-life balance as well as to provide suggestions for meeting the user's desired work-life balance if the user's current work-life balance is not acceptable to them.

### SUMMARY

In one embodiment of the present invention, a method for assisting users to maintain a desired work-life balance comprises receiving a desired work-life balance ratio from a user, where the work-life balance ratio is expressed as a ratio of time spent between two or more categories among work and lifestyle. The method further comprises analyzing, by a processor, one or more calendar systems to determine a current work-life balance ratio over a duration of time. The method additionally comprises analyzing, by the processor, an activity pool containing a list of activities to identify activities to suggest to the user to enable the current work-life balance ratio to match the desired work-life balance ratio in response to the current work-life balance ratio not matching the desired work-life balance ratio. Furthermore, the method comprises providing the identified list of activities from the activity pool to the user.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a communication system configured in accordance with an embodiment of the present invention;

FIG. 2 illustrates an embodiment of the present invention of a hardware configuration of a work-life balance analyzer configured in accordance with an embodiment of the present invention;

FIG. 3 is a flowchart of a method for registering with the work-life balance analyzer in accordance with an embodiment of the present invention;

FIG. 4 illustrates a work-life balance ratio displayed on the user's computing device's user interface expressed as a ratio of time spent among the categories of work, leisure and family in accordance with an embodiment of the present invention;

FIG. 5 illustrates an alternative embodiment of displaying a work-life balance ratio on the user's computing device's user interface as a ratio among calendar systems in accordance with an embodiment of the present invention;

FIG. 6 is a flowchart of a method for establishing the activity pool in accordance with an embodiment of the present invention;

FIG. 7 is a flowchart of a method for assisting users to maintain a desired work-life balance in accordance with an embodiment of the present invention;

FIG. 8 illustrates activities suggested by the work-life balance analyzer that are displayed on the user's computing device's user interface in accordance with an embodiment of the present invention; and

FIG. 9 illustrates an activity selected by the user out of the suggested activities displayed to the user, where the user can send an invitation to the suggested invitee to participate in the selected activity, in accordance with an embodiment of the present invention.

### DETAILED DESCRIPTION

The present invention comprises a method, system and computer program product for assisting users to maintain a desired work-life balance. In one embodiment of the present invention, a work-life balance ratio is provided by the user. A “work-life balance,” as used herein, refers to a balance between work (e.g., career and ambition) and lifestyle (e.g., health, pleasure, leisure, family and spiritual development/meditation). A “work-life balance ratio,” as used herein, refers to a ratio of time spent between two or more categories (e.g., work, leisure, family) among work and lifestyle. One or more calendar systems (e.g., Google® calendar, calendar storing work-related activities) used by the user are analyzed to determine the user's current work-life balance ratio over a duration of time (e.g., upcoming week). An activity pool containing a list of activities is analyzed to identify activities to suggest to the user to enable the current work-life balance ratio to match the desired work-life balance ratio in response to the current work-life balance ratio not matching the desired work-life balance ratio. A list of the activities identified is then provided to the user to enable the current work-life balance ratio to match the desired work-life balance ratio. In this manner, the user is better able to achieve the user's desired work-life balance.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

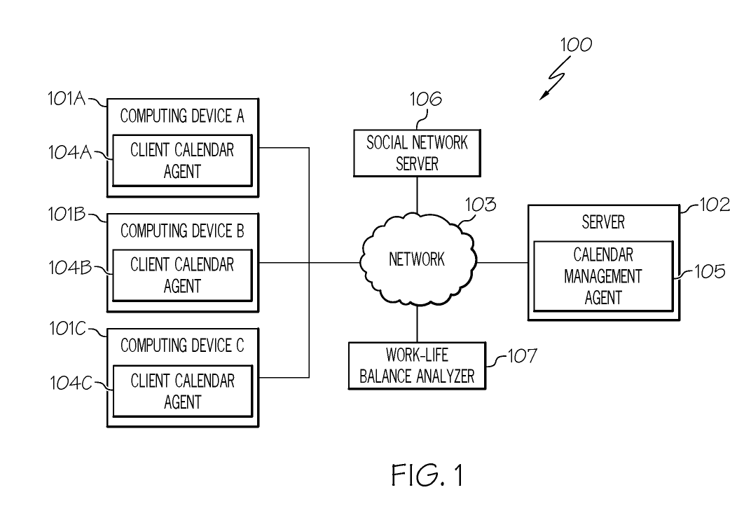

Referring now to the Figures in detail, FIG. 1 illustrates an embodiment of the present invention of a communication system 100 for practicing the principles of the present invention in accordance with an embodiment of the present invention. Communication system 100 includes computing devices 101A-101C (identified as “Computing Device A,” “Computing Device B,” and “Computing Device C,” respectively, in FIG. 1) connected to a server 102 via a network 103. Computing devices 101A-101C may collectively or individually be referred to as computing devices 101 or computing device 101, respectively. It is noted that both computing devices 101 and the users of computing devices 101 may be identified with element number 101.

Computing device 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to network 103 and consequently communicating with other computing devices 101 and server 102.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

Computing devices 101 may be configured to send out calendar appointments or meeting notices/invitations to other computing devices 101 using a calendar application (not shown) via network 103. Any user of computing device 101 may be the creator or initiator of an activity/event invitation (e.g., meeting invitation) and any user of computing device 101 may be a recipient of an activity/event invitation.

In one embodiment, computing devices 101A-101C include a software agent, referred to herein as a client calendar agent 104A-104C, respectively. Client calendar agents 104A-104C may collectively or individually be referred to as client calendar agents 104 or client calendar agent 104, respectively. Furthermore, server 102 includes a software agent, referred to herein as the calendar management agent 105. Calendar management agent 105 interfaces with client calendar agent 104 to present invitations to computing device 101. Client calendar agent 104 is configured to display the received invitation as well as display calendar schedule information on the calendar user interface of computing device 101.

System 100 further includes a social network server 106, which may be a web server configured to offer a social networking and/or microblogging service, enabling users of computing devices 101 to send and read other users' posts. “Posts,” as used herein, include any one or more of the following: text (e.g., comments, sub-comments and replies), audio, video images, etc. Social network server 106 is connected to network 103 by wire or wirelessly. While FIG. 1 illustrates a single social network server 106, it is noted for clarity that multiple servers may be used to implement the social networking and/or microblogging service.

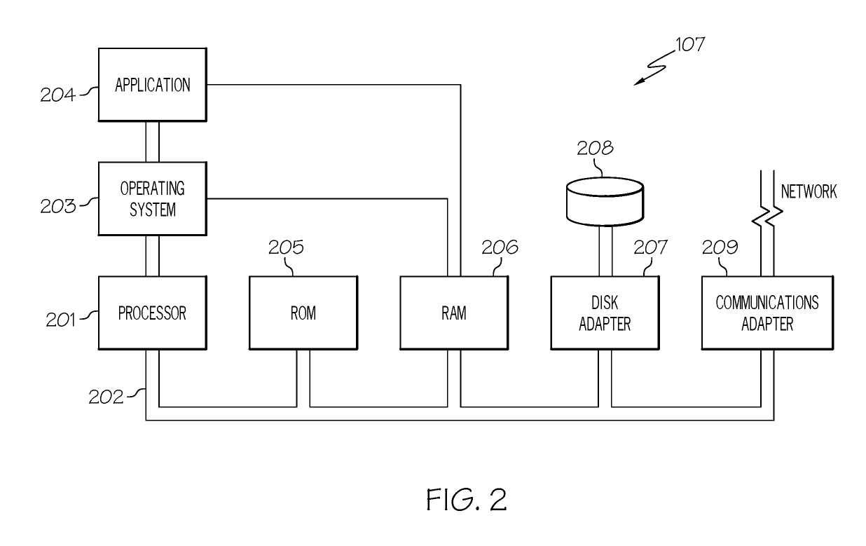

System 100 further includes a unit 107, referred to herein as the “work-life balance analyzer,” connected to network 103 via wire or wirelessly. Work-life balance analyzer 107 is configured to analyze calendar systems (e.g., Google® calendar) of user 101 to determine the user's current work-life balance and to recommend activities/events to user 101 to assist user 101 in reaching a desired work-life balance if the user's current work-life balance is not satisfactory to user 101 as discussed further below. A description of the hardware configuration of work-life balance analyzer 107 is provided below in connection with FIG. 2.

System 100 is not to be limited in scope to any one particular network architecture. System 100 may include any number of computing devices 101, servers 102, networks 103, social network servers 106 and work-life balance analyzers 107.

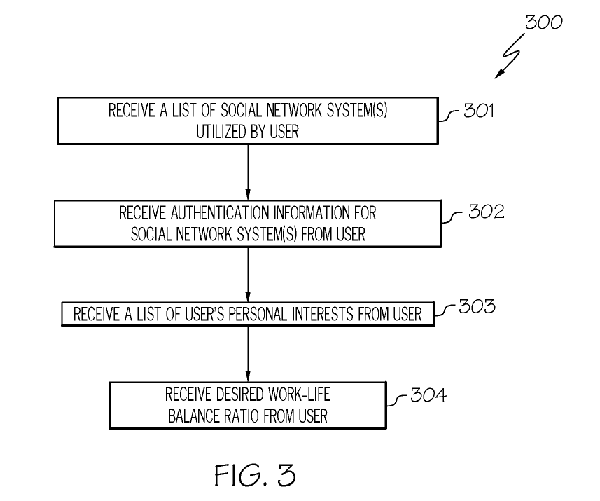

Referring now to FIG. 2, FIG. 2 illustrates an embodiment of the present invention of a hardware configuration of work-life balance analyzer 107 (FIG. 1), which is representative of a hardware environment for practicing the present invention. Referring to FIG. 2, work-life balance analyzer 107 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for assisting users 101 (FIG. 1) to maintain a desired work-life balance as discussed further below in connection with FIGS. 3-9.

Referring again to FIG. 2, read-only memory (“ROM”) 205 is coupled to system bus 202 and includes a basic input/output system (“BIOS”) that controls certain basic functions of work-life balance analyzer 107. Random access memory (“RAM”) 206 and disk adapter 207 are also coupled to system bus 202. It should be noted that software components including operating system 203 and application 204 may be loaded into RAM 206, which may be work-life balance analyzer's 107 main memory for execution. Disk adapter 207 may be an integrated drive electronics (“IDE”) adapter that communicates with a disk unit 208, e.g., disk drive. It is noted that the program for assisting users 101 (FIG. 1) to maintain a desired work-life balance, as discussed further below in connection with FIGS. 3-9, may reside in disk unit 208 or in application 204.

Work-life balance analyzer 107 may further include a communications adapter 209 coupled to bus 202. Communications adapter 209 interconnects bus 202 with an outside network (e.g., network 103 of FIG. 1) thereby allowing work-life balance analyzer 107 to communicate with devices, such as computing devices 101, servers 102 and social network servers 106.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, currently, people have become more concerned about maintaining a “work-life balance” where they attempt to establish a balance between work (e.g., career and ambition) and lifestyle (e.g., health, pleasure, leisure, family and spiritual development/meditation). In connection with maintaining such a work-life balance, people may manually enter activities (e.g., work, leisure and family activities) into a calendar system so as to track their schedule to determine if they are maintaining their desired work-life balance. However, determining one's current work-life balance in such a manner may be difficult, such as in the scenario where the user has an excessive number of activities scheduled in the user's calendar. Even if a person is able to determine their work-life balance from their calendar, the person may be unsure how to incorporate more activities, such as lifestyle activities, to achieve their desired work-life balance if the person's current work-life balance is not acceptable to them. Hence, there is not currently a means for assisting users to determine their current work-life balance as well as to provide suggestions for meeting the user's desired work-life balance if the user's current work-life balance is not acceptable to them.

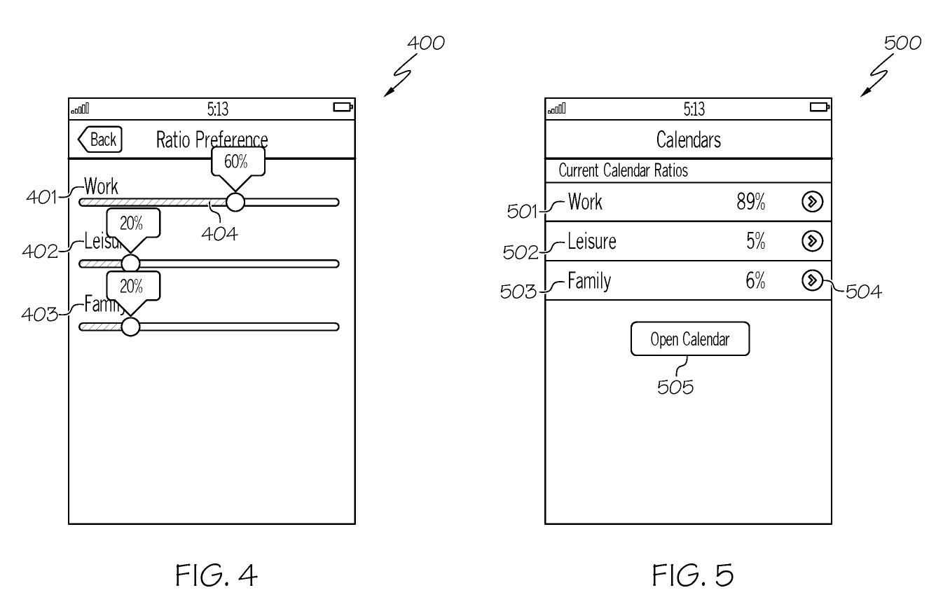

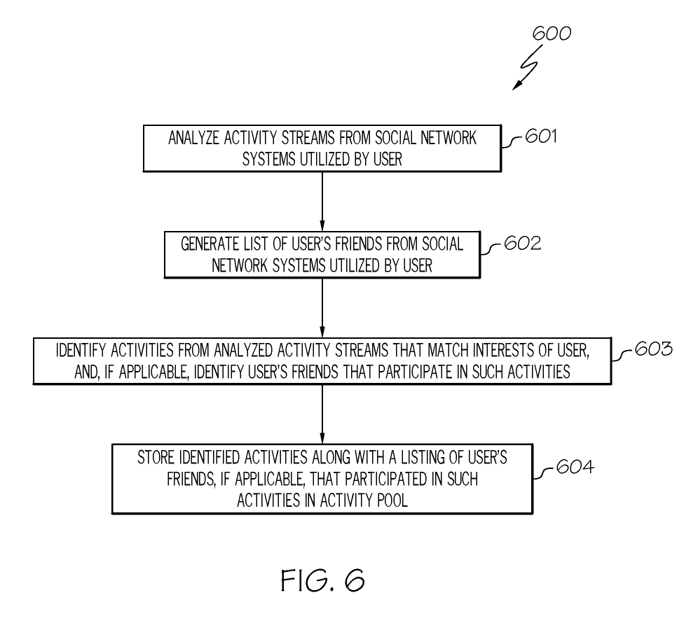

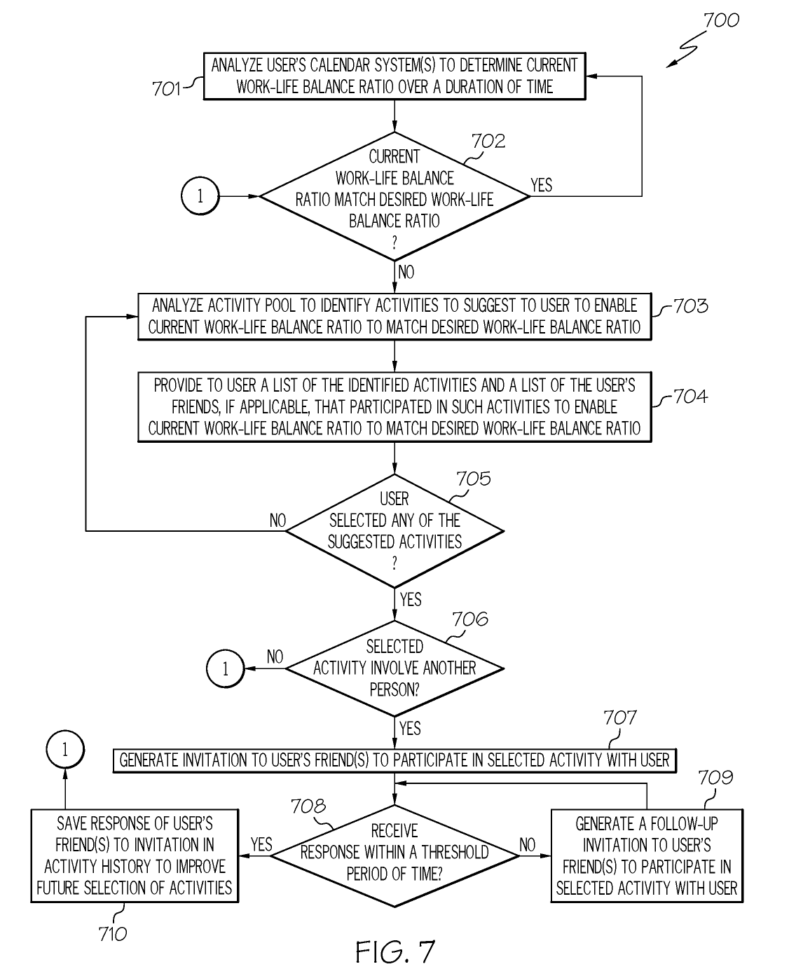

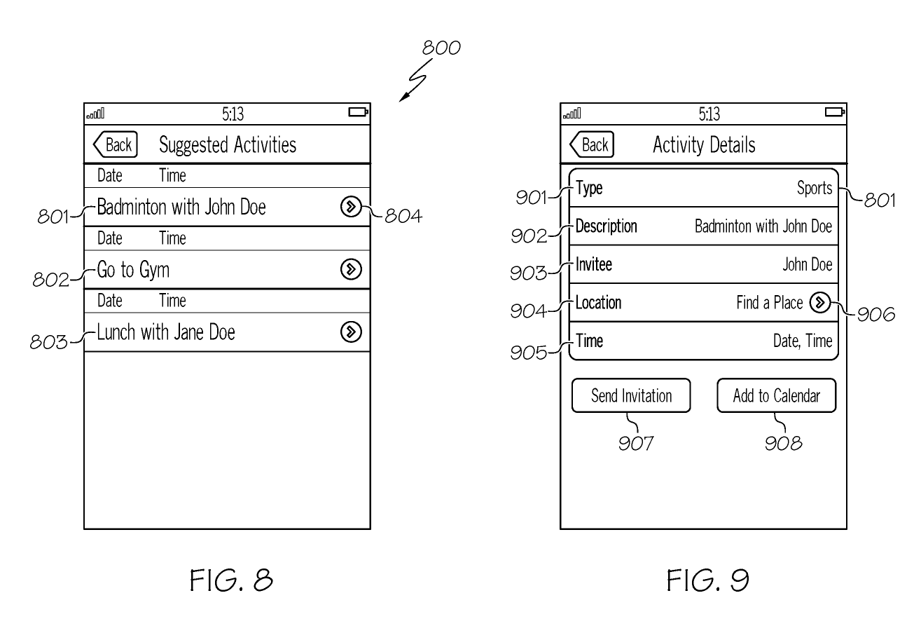

The principles of the present invention provide a means for assisting users to determine their current work-life balance as well as to provide suggestions for meeting the user's desired work-life balance if the user's current work-life balance is not acceptable to them as discussed below in connection with FIGS. 3-9. FIG. 3 is a flowchart of a method for registering with work-life balance analyzer 107 (FIG. 1). FIG. 4 illustrates a work-life balance ratio displayed on the user's computing device's user interface expressed as a ratio of time spent among the categories of work, leisure and family. FIG. 5 illustrates an alternative embodiment of displaying a work-life balance ratio on the user's computing device's user interface as a ratio among calendar systems. FIG. 6 is a flowchart of a method for establishing the activity pool. FIG. 7 is a flowchart of a method for assisting users to maintain a desired work-life balance. FIG. 8 illustrates activities suggested by work-life balance analyzer 107 that are displayed on the user's computing device's user interface. FIG. 9 illustrates an activity selected by the user out of the suggested activities displayed to the user, where the user can send an invitation to the suggested invitee to participate in the selected activity.

As stated above, FIG. 3 is a flowchart of a method 300 for registering with work-life balance analyzer 107 (FIG. 1) in accordance with an embodiment of the present invention.

Referring to FIG. 3, in connection with FIGS. 1-2, in step 301, work-life balance analyzer 107 receives from user 101 a list of social network system(s) utilized by user 101. For example, user 101 may provide a list of social network systems (e.g., Facebook®, LinkedIn®, Google+®) utilized by user 101 via a user interface of computing device 101.

In step 302, work-life balance analyzer 107 receives from user 101 authentication information for the social network system(s) previously provided by user 101 in step 301. In this manner, work-life balance analyzer 107 will be able to access those social network system(s) and analyze the user's activity streams in those social network system(s) as discussed further below. In one embodiment, the authentication information may be provided to work-life balance analyzer 107 by user 101 via a user interface of computing device 101.

In step 303, work-life balance analyzer 107 receives from user 101 a list of the user's personal interests (e.g., hockey, baseball, traveling). Such a list will be utilized by work-life balance analyzer 107 to identify activities of interest to user 101 as discussed further below. In one embodiment, the user's personal interests may be provided to work-life balance analyzer 107 by user 101 via a user interface of computing device 101.

In step 304, work-life balance analyzer 107 receives a desired work-life balance ratio from user 101. In one embodiment, such information may be provided to work-life balance analyzer 107 by user 101 via a user interface of computing device 101. A “work-life balance,” as used herein, refers to a balance between work (e.g., career and ambition) and lifestyle (e.g., health, pleasure, leisure, family and spiritual development/meditation). A “work-life balance ratio,” as used herein, refers to a ratio of time spent between two or more categories (e.g., work, leisure, family) among work and lifestyle as illustrated in FIG. 4. In one embodiment, such categories may be selected by user 101.

FIG. 4 illustrates a work-life balance ratio 400 displayed on the user interface of computing device 101 expressed as a ratio of time spent among the categories of work 401, leisure 402 and family 403 in accordance with an embodiment of the present invention. As illustrated in FIG. 4, in one embodiment, such a ratio may be expressed in terms of percentages selected by user 101 via a slider 404.

FIG. 5 illustrates an alternative embodiment of displaying a work-life balance ratio 500 on the user interface of computing device 101 as a ratio among calendar systems in accordance with an embodiment of the present invention. As illustrated in FIG. 5, user 101 may have designated particular calendar systems to store calendar information for particular types of categories involving work and lifestyle. For example, one calendar system 501 may be designated to store calendar information for work-related activities. Another calendar system 502 may be designated to store calendar information for leisure-related activities. A further calendar system 503 may be designated to store family-related activities. In one embodiment, user 101 selects a percentage of time for activities to be performed in categories involving work and lifestyle (e.g., work, leisure, family) whose calendar information is stored in particular calendar systems. In other words, user 101 may designate a work-life balance ratio among calendar systems, such as via percentages as shown in FIG. 5. In one embodiment, the work-life balance ratio may be established among calendar systems, such as via an arrow icon 504, where after user 101 selects arrow icon 504, user 101 may be able to input a particular percentage of time for activities to be performed in the category or calendar system associated with that icon. Furthermore, in one embodiment, user 101 may be presented with an option to open the calendar (see “open calendar” icon 505) where user 101 would be able to view the electronic calendar of events/activities for one of the selected calendar systems.

After the user's desired work-life balance ratio is received by work-life balance analyzer 107, work-life balance analyzer 107 may establish the activity pool of activities that are used by work-life balance analyzer 107 to suggest activities to user 101 to enable user 101 to meet the user's desired work-life balance ratio as discussed below in connection with FIG. 6.

FIG. 6 is a flowchart of a method 600 for establishing the activity pool in accordance with an embodiment of the present invention.

Referring to FIG. 6, in conjunction with FIGS. 1-5, in step 601, work-life balance analyzer 107 analyzes the activity streams from the social network systems utilized by user 101. That is, work-life balance analyzer 107 analyzes the activity streams from the social network systems provided by user 101 in step 301. As discussed above, work-life balance analyzer 107 is able to access and analyze the activity streams from the social network systems provided by user 101 in step 301 since user 101 provided the user's authentication credentials to such social network systems to work-life balance analyzer 107. In one embodiment, analyzing activity streams involves identifying events or activities discussed in the user's activity streams (e.g., Facebook's® News Feed) in the social networks utilized by user 101. Such analysis involves the use of natural language processing where keywords may be identified in the activity stream to identify events or activities, such as “meeting,” “tennis,” “baseball,” “go out,” “work,” “game,” and “beach.” For instance, suppose that a message was posted on the user's activity stream involving one of the user's friends going to a baseball game. Work-life balance analyzer 107 would be able to detect the event of one of the user's friends going to the baseball game by identifying keywords, such as baseball and game.

In step 602, work-life balance analyzer 107 generates a list of the user's friends from the social network systems utilized by user 101. For example, work-life balance analyzer 107 may generate a list of the user's friends on the user's social networks via the user's friend lists. In another example, work-life balance analyzer 107 may infer the user's friends based on activities participated by user 101 with other users. For example, if there is a post involving user 101 and another person attending an event, it may be inferred by work-life balance analyzer 107 that the person who attended the event with user 101 is a friend of user 101.

In step 603, work-life balance analyzer 107 identifies activities from the analyzed activity streams that match the interests of user 101, and, if applicable, identifies friends of user 101 that participate in such activities. “Activities,” as used herein, refer to events involving work and lifestyle actions. Such actions identified in the analyzed activity streams may occur in the present, past or future. As discussed above, user 101 may provide work-life balance analyzer 107 a list of interests (e.g., tennis, baseball, movies, art museums, travel). These interests may be used by work-life balance analyzer 107 to determine if any of the activities identified in the user's activity streams in the social networks utilized by user 101 would be of interest to user 101 using natural language processing. For instance, if user 101 has expressed an interest in attending art museum, and a post was identified on the user's activity stream that discusses that the user's friends attended a local art museum recently, then such an activity would be identified as matching one of the interests of user 101. Also, the friends of user 101 that attended the art museum would be identified as participating in that activity (i.e., attending the art museum).

It is noted that some activities, such as going to the gym, need not involve other users (e.g., friends). For example, user 101 may post about how much he/she enjoys going to the gym but has had a hard time finding time to attend. Work-life balance analyzer 107 may infer that such an activity is of an interest to user 101 via natural language processing based on the fact that user 101 has expressed a desire to participate in such an activity.

In step 604, work-life balance analyzer 107 stores the identified activities along with a listing of the user's friends, if applicable, that participated in such activities in what is referred to herein as the “activity pool.” In one embodiment, the activity pool is a data structure stored in a data storage unit (e.g., memory 205, disk unit 208) of work-life balance analyzer 107.

These activities will be used by work-life balance analyzer 107 to suggest activities to user 101 to meet the user's desired work-life balance ratio as discussed below in connection with FIG. 7.

FIG. 7 is a flowchart of a method 700 for assisting users to maintain a desired work-life balance in accordance with an embodiment of the present invention.

Referring to FIG. 7, in conjunction with FIGS. 1-6, in step 701, work-life balance analyzer 107 analyzes the user's calendar system(s) (e.g., Google® calendar, calendar storing work-related activities) to determine the current work-life balance ratio over a duration of time (e.g., upcoming week). In one embodiment, work-life balance analyzer 107 identifies the category (e.g., work, leisure, family) among work and lifestyle activities in the analyzed calendar systems using natural language processing by identifying keywords (e.g., “work,” “meeting,” “baseball,” “son”). For example, in the user's calendar, there may be a time blocked out for attending a baseball game with the user's son. Work-life balance analyzer 107 may identify such an activity as being associated with a family activity since it involves the user's son. In one embodiment, work-life balance analyzer 107 may assume that if there is no indication in the user's calendar of an activity during working hours, then such a block of time is to be deemed to be a work-related activity. Conversely, user 101 may inform work-life balance analyzer 107 that certain hours during the weekend are assumed to be dedicated to family or leisure activities if no activities are listed in the user's calendar during that period of time.

A work-life balance ratio may then be determined by work-life balance analyzer 107 by determining the amount of time spent in each category (e.g., work, leisure, family) among work and lifestyle activities over a duration of time (e.g., a week). For example, if user 101 spends 80% of his/her time doing work-related activities, 10% of his/her time doing leisure-related activities and 10% of his/her time doing family-related activities during the upcoming week, then work-life balance analyzer 107 may determine that the work-life balance ratio among the categories of work, leisure and family is 80%, 10% and 10%, respectively.

In step 702, a determination is made by work-life balance analyzer 107 as to whether the current work-life balance ratio matches the desired work-life balance ratio (user 101 previously provided the user's desired work-life balance ratio to work-life balance analyzer 107 in step 304). In one embodiment, such a determination may be based on whether the current work-life balance ratio is within a threshold degree of matching the desired work-life balance ratio. For example, if the current work-life balance ratio is a value that is within 2% or less of the value of the desired work-life balance ratio, then work-life balance analyzer 107 may determine that in essence the current work-life balance ratio matches the desired work-life balance ratio.

If the current work-life balance matches the desired work-life balance ratio, then work-life balance analyzer 107 continues to analyze the user's calendar system(s) to determine the current work-life balance ratio over a duration of time (e.g., upcoming week) in step 701.

If, however, the current work-life balance does not match the desired work-life balance ratio, then, in step 703, work-life balance analyzer 107 analyzes the activity pool to identify activities to suggest to user 101 to enable the current work-life balance ratio to match the user's desired work-life balance ratio.

For example, if user 101 indicated (such as in step 304) that the desired work-life balance ratio among the categories of work, leisure and family is to be 60%, 20% and 20%, respectively, and the current work-life balance (determined in step 701) among the categories of work, leisure and family is 80%, 10% and 10%, respectively, then work-life balance analyzer 107 determines that user 101 needs more activities in the leisure and family categories and less activities in the work category. As a result, work-life balance analyzer 107 analyzes the activity pool for activities in the leisure and family categories to suggest to user 101 to help user 101 reach the user's desired work-life balance. For instance, work-life balance analyzer 107 may identify activities in a particular category (e.g., leisure and family) using natural language processing. For example, work-life balance analyzer 107 may identify activities in a particular category, such as leisure, by focusing on keywords involving leisure activities, such as “art museum,” “hockey,” etc. In another example, work-life balance analyzer 107 may identify activities in a particular category, such as family, by focusing on keywords involving activities that are family centered (e.g., movies) or activities that are enjoyed by family members. For instance, work-life balance analyzer 107 may analyze the social profiles of the user's family members to determine their activities of interest. As a result, work-life balance analyzer 107 will be able to identify those activities that are of interest to the user's family members that also match the interests of user 101.

In step 704, work-life balance analyzer 107 provides to user 101 a list of the identified activities (identified in step 703) and a list of the user's friends, if applicable, that participated in such activities (acquired from the activity pool which contains a list of activities as well as a listing of the user's friends, if applicable, that participated in such activities) to enable the current work-life balance ratio to match the desired work-life balance ratio as illustrated in FIG. 8. In this manner, the present invention assists users to not only determine their current work-life balance but also to provide suggestions for meeting the user's desired work-life balance if the user's current work-life balance is not acceptable to them.

FIG. 8 illustrates the activities suggested by work-life balance analyzer 107 that is displayed on the user interface of computing device 101 in accordance with an embodiment of the present invention. As illustrated in FIG. 8, work-life balance analyzer 107 provides a list of suggested activities 800 that includes the activity of playing badminton with John Doe (activity 801), the activity of going to the gym (activity 802) and the activity of going to lunch with Jane Doe (activity 803). In one embodiment, work-life balance analyzer 107 provides a listing of one or more friends to participate with user 101 involving the suggested activity. As previously discussed, the activity pool stores both the activities as well as the list of users, if applicable, who participated in such activities. As discussed further below, if user 101 selects an activity that has been participated by the user's friends, then work-life balance analyzer 107 may generate an invitation to those friend(s) to participate in the selected activity.

In one embodiment, a date and time may be suggested along with the suggested activity. In one embodiment, such a date and time may be determined based on the user's calendar (e.g., identify a block of time that user 101 does not currently have a conflict with such an activity) as well as possibly the calendar of the user's friend(s), if applicable, who are to receive an invitation concerning the selected activity. In one embodiment, work-life balance analyzer 107 may determine the user's friend's schedule by analyzing the friend's public social profile as well as any other publicly available electronic calendar of the user's friend.

In one embodiment, user 101 may select one of the suggested activities to participate, such as via an arrow icon 804, as illustrated in FIG. 9.

FIG. 9 illustrates an activity selected by user 101 out of the suggested activities displayed to user 101, where user 101 can send an invitation to the suggested invitee to participate in the selected activity in accordance with an embodiment of the present invention.

Referring to FIG. 9, in conjunction with FIG. 8, as a result of user 101 selecting activity 801, such as via arrow icon 804, details regarding activity 801 will be displayed to user 101 on the user interface of computing device 101 as shown in FIG. 9. Such details include the type 901 of activity (e.g., sports), the description 902 of the activity (e.g., playing badminton with John Doe), the invitee 903 of the activity (e.g., John Doe), the location 904 of the activity and the date and time 905 of the activity. In one embodiment, user 101 may select a particular location for the activity to occur out of a listing of possible locations determined by work-life balance analyzer 107 by selecting arrow icon 906. In one embodiment, work-life balance analyzer 107 may determine a set of possible locations based on previous locations as to where the selected activity occurred. In one embodiment, these previous locations may have been identified from analyzing the activity streams of the user's social networks where posts regarding the activity discussed the location of the activity.

Furthermore, FIG. 9 illustrates the option of user 101 sending an invitation via invitation icon 907 (“Send Invitation”) regarding the activity (e.g., badminton) to the invitee 903 (e.g., John Doe). Furthermore, user 101 is presented the option with adding the activity to the user's calendar via icon 908 (“Add to Calendar”).

Returning to FIG. 7, in conjunction with FIGS. 1-6 and 8-9, in step 705, a determination is made by work-life balance analyzer 107 as to whether user 101 selected any of the suggested activities to participate.

If user 101 did not select any of the suggested activities to participate, then work-life balance analyzer 107 further analyzes the activity pool to identify further activities to suggest to user 101 to enable the current work-life balance ratio to match the user's desired work-life balance ratio in step 703.

If, however, user 101 selected an activity suggested by work-life balance analyzer 107 to participate, then, in step 706, a determination is made by work-life balance analyzer 107 as to whether the selected activity involves another person.

If the selected activity does not involve another person (e.g., going to the gym), then work-life balance analyzer 107 then determines if the current work-life balance ratio now matches the desired work-life balance ratio in step 702.

If, however, the selected activity involves another person, then, in step 707, work-life balance analyzer 107 generates an invitation to the user's friend(s) to participate in the selected activity with user 101 as discussed above in connection with FIG. 9. In one embodiment, such friend(s) were identified in the activity pool as having been associated with such an activity. That is, such friend(s) were identified in the activity pool as having previously participated in such an activity or indicated a desire to participate in such an activity.

In step 708, a determination is made by work-life balance analyzer 107 as to whether user 101 received a response within a threshold period of time (e.g., within six hours). In one embodiment, the threshold period of time is user-selected.

If user 101 did not receive a response within the threshold period of time, then, in step 709, work-life balance analyzer 107 generates a follow-up invitation to the user's friend(s) to participate in the selected activity with user 101. Work-life balance analyzer 107 then determines whether user 101 received a response within a threshold period of time in step 708.

If, however, work-life balance analyzer 107 received a response within the threshold period of time, then, in step 710, work-life balance analyzer 107 saves the response of the user's friend(s) to the invitation in the activity history to improve the future selection of activities. In one embodiment, the activity history is a data structure stored in a data storage unit (e.g., memory 205, disk unit 208) of work-life balance analyzer 107. For example, if the user's friend(s) are not accepting the invitations to participate in a particular type of activity (e.g., attending baseball game), then it may be inferred that the user's friend(s) do not have an interest in participating in such an activity. Other information that may be inferred from the invitation responses include confirming the user's friend's interests, scheduling conflicts and alternative activities, times and dates based on responses that suggest alternatives (e.g., suggest alternative time or activity).

Upon saving the responses from the user's friend(s) to the invitation, work-life balance analyzer 107 determines if the current work-life balance ratio now matches the desired work-life balance ratio in step 702.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for assisting users to maintain a desired work-life balance, the method comprising:
receiving a desired work-life balance ratio from a user, wherein said work-life balance ratio is expressed as a ratio of time spent between two or more categories among work and lifestyle;
analyzing, by a processor, one or more calendar systems to determine a current work-life balance ratio over a duration of time;
analyzing, by said processor, an activity pool containing a list of activities to identify activities to suggest to said user to enable said current work-life balance ratio to match said desired work-life balance ratio in response to said current work-life balance ratio not matching said desired work-life balance ratio; and
providing said identified list of activities from said activity pool to said user.

2. The method as recited in claim 1, wherein said activity pool contains said list of activities along with a listing of user's friends that participate in one or more of said activities, wherein the method further comprising:
providing said identified list of activities and a listing of user's friends that participate in one or more of said identified activities to said user; and
generating an invitation to one or more friends of said user to participate in an activity of said identified list of activities in response to said user selecting said activity of said identified list of activities.

3. The method as recited in claim 2 further comprising:
generating a follow-up invitation to one or more of said one or more friends of said user to participate in said activity of said identified list of activities in response to not receiving a response to said invention from said one or more of said one or more friends of said user.

4. The method as recited in claim 2 further comprising:
saving a response from a friend of said user who received said invitation.

5. The method as recited in claim 1 further comprising:
receiving a list of one or more social network systems utilized by said user; and
receiving a list of personal interests of said user.

6. The method as recited in claim 5 further comprising:
analyzing activity streams from said one or more social network systems utilized by said user;
generating a list of friends of said user from said one or more social network systems utilized by said user;
identifying activities from said analyzed activity streams that match said personal interests of said user and identifying any friends of said user that participated in such activities; and
storing said identified activities that match said personal interests of said user along with any friends of said user that participated in such activities in said activity pool.

7. The method as recited in claim 1, wherein said two or more categories comprise work, leisure and family.

8. The method as recited in claim 1, wherein said work-life balance ratio is expressed as said ratio of time spent between two or more categories using two or more calendar systems.

9. A computer program product for assisting users to maintain a desired work-life balance, the computer program product comprising a computer readable storage medium having program code embodied therewith, the program code comprising the programming instructions for:
receiving a desired work-life balance ratio from a user, wherein said work-life balance ratio is expressed as a ratio of time spent between two or more categories among work and lifestyle;
analyzing one or more calendar systems to determine a current work-life balance ratio over a duration of time;
analyzing an activity pool containing a list of activities to identify activities to suggest to said user to enable said current work-life balance ratio to match said desired work-life balance ratio in response to said current work-life balance ratio not matching said desired work-life balance ratio; and
providing said identified list of activities from said activity pool to said user.

10. The computer program product as recited in claim 9, wherein said activity pool contains said list of activities along with a listing of user's friends that participate in one or more of said activities, wherein the program code further comprises the programming instructions for:
providing said identified list of activities and a listing of user's friends that participate in one or more of said identified activities to said user; and
generating an invitation to one or more friends of said user to participate in an activity of said identified list of activities in response to said user selecting said activity of said identified list of activities.

11. The computer program product as recited in claim 10, wherein the program code further comprises the programming instructions for:
generating a follow-up invitation to one or more of said one or more friends of said user to participate in said activity of said identified list of activities in response to not receiving a response to said invention from said one or more of said one or more friends of said user.

12. The computer program product as recited in claim 10, wherein the program code further comprises the programming instructions for:
saving a response from a friend of said user who received said invitation.

13. The computer program product as recited in claim 9, wherein the program code further comprises the programming instructions for:
receiving a list of one or more social network systems utilized by said user; and
receiving a list of personal interests of said user.

14. The computer program product as recited in claim 13, wherein the program code further comprises the programming instructions for:
analyzing activity streams from said one or more social network systems utilized by said user;
generating a list of friends of said user from said one or more social network systems utilized by said user;
identifying activities from said analyzed activity streams that match said personal interests of said user and identifying any friends of said user that participated in such activities; and
storing said identified activities that match said personal interests of said user along with any friends of said user that participated in such activities in said activity pool.

15. The computer program product as recited in claim 9, wherein said two or more categories comprise work, leisure and family.

16. The computer program product as recited in claim 9, wherein said work-life balance ratio is expressed as said ratio of time spent between two or more categories using two or more calendar systems.

17. A system, comprising:
a memory unit for storing a computer program for assisting users to maintain a desired work-life balance; and
a processor coupled to the memory unit, wherein the processor is configured to execute the program instructions of the computer program comprising:
receiving a desired work-life balance ratio from a user, wherein said work-life balance ratio is expressed as a ratio of time spent between two or more categories among work and lifestyle;
analyzing one or more calendar systems to determine a current work-life balance ratio over a duration of time;
analyzing an activity pool containing a list of activities to identify activities to suggest to said user to enable said current work-life balance ratio to match said desired work-life balance ratio in response to said current work-life balance ratio not matching said desired work-life balance ratio; and
providing said identified list of activities from said activity pool to said user.

18. The system as recited in claim 17, wherein said activity pool contains said list of activities along with a listing of user's friends that participate in one or more of said activities, wherein the program instructions of the computer program further comprise:
providing said identified list of activities and a listing of user's friends that participate in one or more of said identified activities to said user; and
generating an invitation to one or more friends of said user to participate in an activity of said identified list of activities in response to said user selecting said activity of said identified list of activities.

19. The system as recited in claim 17, wherein the program instructions of the computer program further comprise:
receiving a list of one or more social network systems utilized by said user; and
receiving a list of personal interests of said user.

20. The system as recited in claim 19, wherein the program instructions of the computer program further comprise:
analyzing activity streams from said one or more social network systems utilized by said user;
generating a list of friends of said user from said one or more social network systems utilized by said user;
identifying activities from said analyzed activity streams that match said personal interests of said user and identifying any friends of said user that participated in such activities; and
storing said identified activities that match said personal interests of said user along with any friends of said user that participated in such activities in said activity pool.
